(19) United States
(12) Patent Application Publication
(10) Pub. No.: US 2025/0026164 A1
(43) Pub. Date: Jan. 23, 2025

(54) MORPHING CROSS-MEDIUM UNMANNED CRAFT

(71) Applicant: WUHAN UNIVERSITY OF TECHNOLOGY, Wuhan (CN)

(72) Inventors: Wulong HU, Wuhan (CN); Siyuan ZUO, Wuhan (CN); Weiguo WU, Wuhan (CN)

(73) Assignee: WUHAN UNIVERSITY OF TECHNOLOGY, Wuhan, HB (CN)

(21) Appl. No.: 18/735,235

(22) Filed: Jun. 6, 2024

(30) Foreign Application Priority Data
Jul. 18, 2023 (CN) 2023108861065

(51) Int. Cl. B60F 5/02; B63B 1/20; B63G 8/00; B63G 8/04; B64C 35/00; B64U 10/70; B64U 50/13; B64U 50/31; B64U 101/00

(52) U.S. Cl. CPC B60F 5/02; B63B 1/20; B63G 8/001; B63G 8/04; B64C 35/005; B64U 10/70; B64U 50/13; B64U 50/31; B63B 2001/208; B63G 2008/002; B64U 2101/00

(57) ABSTRACT

The present invention provides a morphing cross-medium unmanned craft, wherein the cross-medium unmanned craft includes a main hull, side hulls set on both sides of the main hull and a propeller; the side hulls can be flipped relative to the main hull, so that the side hulls can have different orientation attitudes relative to the main hull, which can make the unmanned craft be variant, realizing the cross-medium navigation function of high-speed flight in the air, energy-saving navigation on the surface of the water; the propeller is used to provide an appropriate power propulsion mode for the unmanned craft when the unmanned craft is in different motion states, so as to improve the matching and reliability of the power propulsion of the unmanned craft in different medium domains of water surface, underwater and air.

### TECHNICAL FIELD

The present invention relates to the technical field of an unmanned craft, especially a morphing cross-medium unmanned craft.

### BACKGROUND ART

In the face of the complex marine environment and the need of performing tasks in the cross-medium domain, the existing marine equipment has its own advantages, but also has the following shortcomings: the air vehicle can reach the mission site at high speed, but they cannot meet the needs of long endurance due to limited carrying energy; the water surface vehicle is greatly affected by the change of somatotype on the endurance, at present, some studies have performed underwater detection of detector equipment and ship bottom, this will further squeeze the energy storage space, and its rapidity is far less than that of the air vehicle, and it is slow to deal with emergencies; underwater vehicle has the best concealment and underwater detection ability, but it is also restricted by the endurance and rapidity. At present, the cross-medium vehicle can combine the advantages of air vehicle, surface vehicle and underwater vehicle better, it has the rapidity of air vehicle and the concealment of underwater vehicle, however, the existing cross-medium vehicle is small in size and light in carrying capacity, which can not meet the requirements of long endurance and independent execution of tasks in the far sea.

### SUMMARY

The purpose of the present invention is to provide a morphing cross-medium unmanned craft, including a main hull, side hulls set on both sides of the main hull respectively, and a propeller set under or behind the main hull; the side hulls can be flipped relative to the main hull, in this way, the side hulls can have different orientation attitudes relative to the main hull, which can make the unmanned craft be variant, realizing the cross-medium navigation function of high-speed flight in the air, energy-saving navigation on the surface of the water, and covert underwater diving; the propeller is used to provide an appropriate power propulsion mode for the unmanned craft when the unmanned craft is in different motion states, improving the matching and reliability of the power propulsion of the cross-medium unmanned craft in different medium domains of water surface, underwater and air.

Concretely speaking, when the cross-medium unmanned craft is in a flight mode, the side hulls on the left and right sides of the main hull are expanded to provide upward force, at this time, the propeller provides forward propulsion to the unmanned craft through jet; when the cross-medium unmanned craft is in a water surface navigation mode, the side hulls on the left and right sides of the main hull can be flipped and folded to both sides of the main hull, it forms a trimaran ship configuration with the main hull, at this time, the unmanned craft can rely on the propeller or the concealed sail to provide power, so as to sail on the water surface; when the cross-medium unmanned craft is in a submergence mode, the side hulls on the left and right sides of the main hull can be flipped and folded to fit with the main hull or be stored in the main hull, at this time, the propeller provides forward propulsion to the unmanned craft by sprinkling.

The cross-medium unmanned craft provided in this application performs variant design on both sides of the hull, achieving the effect of cross-medium navigation and further drag reduction and range extension; on the one hand, the side hulls can be flipped and folded to become the left and right wings of the main hull, so as to provide upward lift for the main hull during high-speed navigation, reduce the water entry area of the main hull, achieve further drag reduction, or directly leave the water surface to achieve high-speed flight in the air; on the other hand, the side hulls can also be folded and folded to fit with the main hull or be stored in the main hull, and the rudders of the side hulls face outwards as the lateral fins of the unmanned craft.

The cross-medium unmanned craft provided in this application innovatively uses the cross-medium high-efficiency jet propulsion system to construct the propeller, when the unmanned craft is in the water surface navigation mode or submarine mode, the system enters a sprinkling propulsion mode; when the unmanned craft is in the flight mode, the system enters a jet propulsion mode.

The main hull of the cross-medium unmanned craft provided in this application adopts energy-saving lines, and the bow shape and stern shape are optimized to achieve the goals of energy saving, anti-slamming, low resistance and high propulsion efficiency; a vertical cross section of the side hulls is an airfoil, which is blunt at the top and thin at the bottom, it has a better effect of wave breaking and drag reduction, and can improve the stability of the unmanned craft. When the unmanned craft sails on the water surface, it can be deformed into a trimaran ship configuration, or the side hulls can be expanded into two wings, the lift generated by the two wings can be used to lift the main hull, reduce the contact area between the main hull and water, and achieve the effect of drag reduction. The unmanned craft is also equipped with a concealed sail, a solar photovoltaic membrane and wave energy converters, it can simultaneously use solar energy, wind energy and wave energy to charge the battery and other energy storage devices of the unmanned boat to realize the ultra-long endurance function of the far sea. In the daily water surface endurance state, the sailing power can be directly used to drive the unmanned craft. When the unmanned craft performs a submergence motion, the side hulls can be flipped and folded to fit with the main hull or stored in the main hull, the rudders of side hulls face outwards as the lateral fins of the unmanned craft to control the dive attitude of the unmanned craft.

The purpose of the present invention is to achieve through the following technical solutions:
the morphing cross-medium unmanned craft, including a main hull, side hulls set on both sides of the main hull respectively, and a rudder set at the rear of the main hull, a propeller set under or behind the main hull, wherein a cross profile of the side hulls is an airfoil and the side hulls can be flipped relative to the main hull, and the rudder can rotate around the longitudinal axis of the main hull;
when the two side hulls are flipped to both sides of the main hull and form a trimaran ship configuration with the main hull, the cross-medium unmanned craft is in a surface navigation mode;
when the two side hulls are expanded relative to the main hull, the cross-medium unmanned craft is in a flight mode, and the two side hulls form the wings on both sides of the main hull;
when the two side hulls are overturned to fit with the two sides of the main hull or are stored inside the main hull, the cross-medium unmanned craft is in a submergence mode, and the two side hulls form the outward rudder or lateral fins on both sides of the main hull;
the propeller can perform different working mode switching respectively when the cross-medium unmanned craft is in water surface navigation mode, flight mode or submergence mode;
the rudder can perform different orientation switching respectively when the cross-medium unmanned craft is in water surface navigation mode, flight mode or submergence mode;
in one of the embodiments, it also includes a wing root set on both sides of the main hull; one end of the wing root is connected with the side of the main hull, the other end is connected with the side hulls; the wing root can fold and rotate relative to the main hull, and the side hulls can fold and rotate relative to the wing root.

In one of the embodiments, when cross-medium unmanned craft is in a water surface navigation mode, the wing root and the side hulls perform actions separately, so that the wing root is horizontally expanded and the side hulls are vertically oriented and parallel to the length direction of the main hull;
the main hull and the side hulls are connected by the wing root to form a trimaran ship configuration;
a cross profile of the side hulls is an airfoil, the leading edge of the thicker airfoil is on the top, and the trailing edge of the thinner airfoil is on the bottom;
the rudder rotates to the upper and lower sides of the tail of the cross-medium unmanned craft, the rudder on the upper side is in the air, as the sail of the cross-medium unmanned craft, it provides forward and steering power for the surface navigation of the cross-medium unmanned craft; the rudder on the lower side is in the water, and acts as the rudder of the cross-medium unmanned craft to control the navigation.

In one of the embodiments, when the cross-medium unmanned craft is in a flight mode, the wing root and the side hulls perform actions separately, so that the wing root and the side hulls are both in horizontal expansion state, forming the wings on both sides of the main hull;
when the cross-medium unmanned craft is in flight mode and navigates on the water surface, the side hulls act as a wing to generate a lifting force, so that the cross-medium unmanned craft can be lifted up; when the cross-medium unmanned craft surface accelerates to the wing to generate a corresponding lift, the cross-medium unmanned craft is completely separated from the water surface and is in the air flight state;
when the cross-medium unmanned craft is in the flight mode, the rudder rotates to both sides of the main hull and tilts upward to form the tail of the cross-medium unmanned craft.

In one of the embodiments, when the cross-medium unmanned craft is in a submergence mode, the wing root and the side hulls perform actions separately, so that the wing root and the side hulls are turned to fit with the two sides of the main hull or to be stored inside the main hull;
when the side hulls are turned over and stored inside the main hull, the leading edge of the side hull faces to the inside of the main hull, and the trailing edge of the side hull faces to the outside of the main hull, which constitutes the lateral fins or stern rudder of the cross-medium unmanned craft during diving; when the side hull flips and fits with the side of the main hull, the leading edge of the side hulls fits the side of the main hull, the trailing edge of the side hull is inclined downward and outward, which constitutes the lateral fins or stern rudder of the cross-medium unmanned craft during diving.

When the cross-medium unmanned craft is in the submergence mode, the stern rudder rotates to the upper and lower sides of the tail of the cross-medium unmanned craft, and together with the trailing edge of the side hulls constitutes the stern rudder of the cross-medium unmanned craft.

In one of the embodiments, when the cross-medium unmanned craft is in a flight mode, the propeller is in a jet propulsion mode; when the cross-medium unmanned craft is in surface navigation mode or submerged mode, the propeller is in a sprinkling propulsion mode.

In one of the embodiments, it also includes the front and rear cabins located at the head and tail of the main hull respectively; the front cabin is interconnected with the rear cabin; when the propeller is in a jet propulsion mode, the air transmission modulation is performed on the front cabin and the rear cabin; when the propeller is in a sprinkling propulsion mode, the water transmission modulation is performed on the front cabin and the rear cabin.

In one of the embodiments, it also includes a concealed sail which is arranged on the rear side of the main hull and can be folded relative to the main hull; the concealed sail can use the wind to drive the cross-medium unmanned craft to move or generate electricity;
or, a fuel generator is arranged inside the main hull for power generation.

In one of the embodiments, it also includes a solar photovoltaic membrane and wave energy converters; the solar photovoltaic membrane is arranged on the surface of the main hull and the surface of the concealed sail; the wave energy converters are arranged at the connection between the side hulls and the main hull.

In one of the embodiments, it also includes an energy storage device; the energy storage device is connected to the concealed sail, the solar photovoltaic membrane, the wave energy converters and the fuel generator for storing electric energy.

Compared with the existing technology, the present invention has the following beneficial effects:
the morphing cross-medium unmanned craft, including the main hull, side hulls set on both sides of the main hull respectively, and the propeller set under or behind the main hull; the side hulls can be flipped over relative to the main hull, in this way, the side hulls have different orientation attitudes relative to the main hull, so that the unmanned craft can perform the variant, achieving high-speed flight in the air, water energy-saving navigation, underwater hidden dive cross-medium navigation function; the propeller is used to provide an appropriate power propulsion mode for the unmanned craft when the unmanned craft is in different motion states, so as to improve the matching and reliability of the power propulsion of the unmanned craft in different medium domains of water surface, underwater and air.

### BRIEF DESCRIPTION OF THE DRAWINGS

In order to more clearly explain the technical scheme in the implementation case of this application, the following will briefly introduce the attached drawings needed in the description of the implementation case. Obviously, the drawings in the following description are only some of the implementation examples of this application. For ordinary technicians in this field, other drawings can be obtained according to these drawings without paying creative work. Wherein:

FIG. 1 is a three-view outline diagram of the cross-medium unmanned craft in the surface navigation mode provided in this application;

FIG. 2 is a three-view outline diagram of the cross-medium unmanned craft in flight mode provided in this application;

FIG. 3 is a three-view sketch of the cross-medium unmanned craft in the submergence mode provided in this application;

FIG. 4 is a first perspective structure diagram of the cross-medium unmanned craft provided in this application;

FIG. 5 is a second view structure diagram of the cross-medium unmanned craft provided in this application;

FIG. 6 is a third perspective structure diagram of the cross-medium unmanned craft provided in this application;

FIG. 7 is a structural diagram of the side hulls and wing root of the cross-medium unmanned craft provided in this application;

FIG. 8 is a structural diagram of a first driving mechanism of the wing root of the cross-medium unmanned craft provided in this application;

FIG. 9 is a structural diagram of a second driving mechanism of the side hull of the cross-medium unmanned craft provided in this application.

FIG. 10 is the structural diagram of a stern rudder of the cross-medium unmanned craft provided in this application.

Labels of drawings: 10. main hull; 11. front cabin; 12. rear cabin; 13. propeller; 14. concealed sail; 20. wing root; 21. the first driving mechanism; 22. hinge sleeve; 23. hinge shaft; 24. the first motor; 25. shaft of side rotation; 26. the second motor 30. side hull; 31. the second driving mechanism; 32. front section shaft; 33. rear section shaft; 34. mortise-tenon joint; 35. the third motor; 36. the fourth motor; 41. stern rudder; 42. stern rudder; 43. shaft; 44. shaft; 45. shaft; 46. shaft.

### DETAILED DESCRIPTION OF THE EMBODIMENTS

In order to make the above purpose, characteristics and advantages of this application more obvious and easy to understand, the following is a detailed description of the specific implementation of this application in combination with the attached drawings. Understandably, the specific implementation examples described are only used to explain the application, not to limit the application. It should also be noted that in order to facilitate the description, only part of the structure related to this application, not all of it, is shown in the attached diagram. Based on the implementation examples in this application, all other implementation examples obtained by ordinary technical personnel in this field without making creative work belong to the scope of protection in this application.

The terms ‘include’ and ‘possess’ in this application and any deformation thereof, with the intention of covering non-exclusive inclusion. For example, processes, methods, systems, products or devices that contain a series of steps or units are not limited to the listed steps or units, but optionally include steps or units that are not listed, or optionally include other steps or units inherent to these processes, methods, products or devices.

Reference to ‘embodiment’ in this article means that a particular feature, structure or characteristic described in conjunction with an embodiment may be included in at least one embodiment of this application. The occurrence of the phrase at each position in the instruction does not necessarily mean the same embodiment, nor is it an independent or alternative embodiment that is mutually exclusive with other embodiments. Technicians in this field understand explicitly and implicitly that the embodiments described in this paper can be combined with other embodiments.

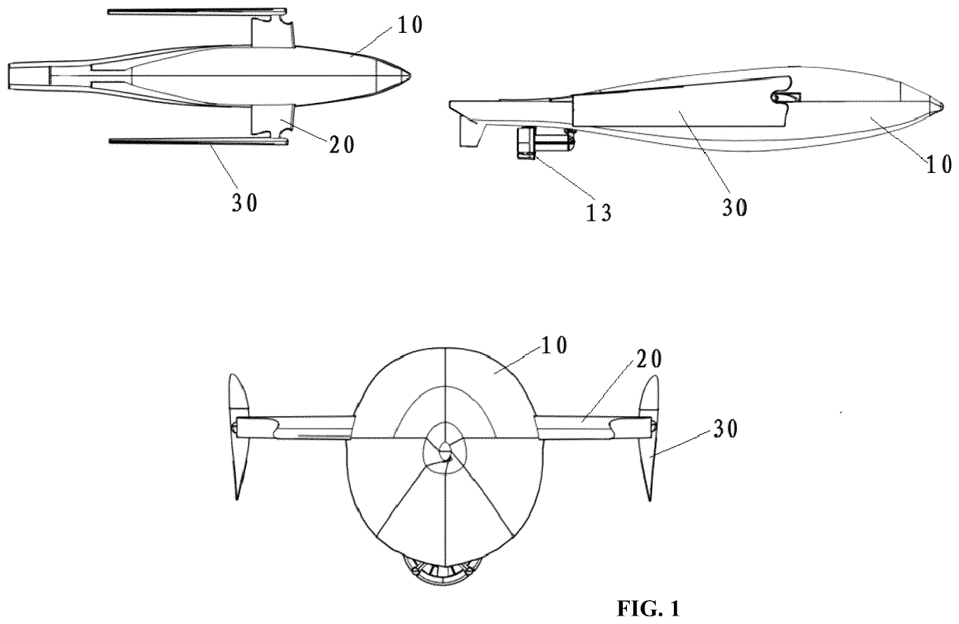

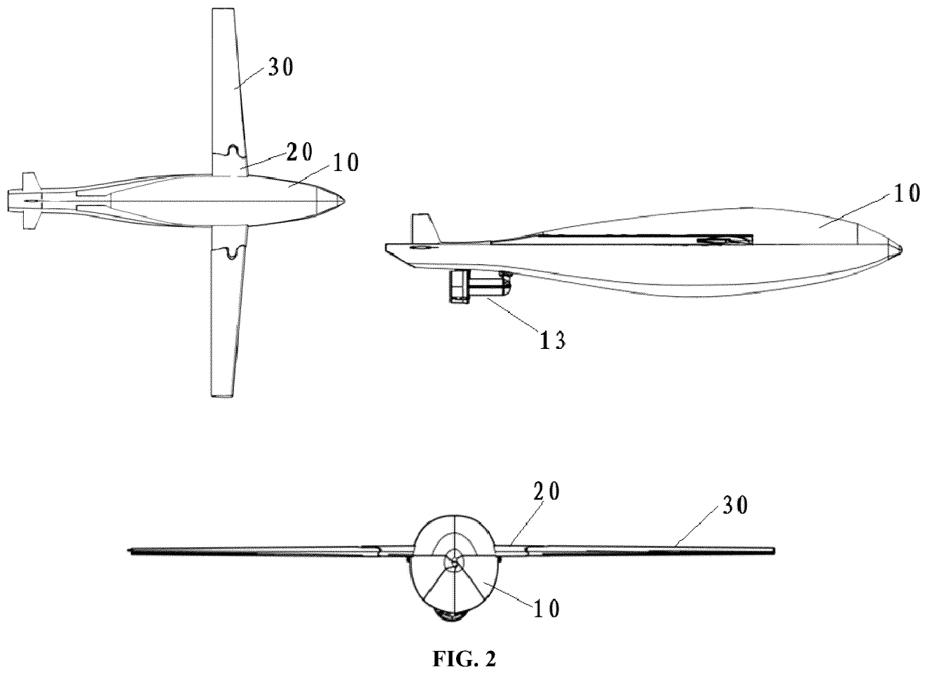

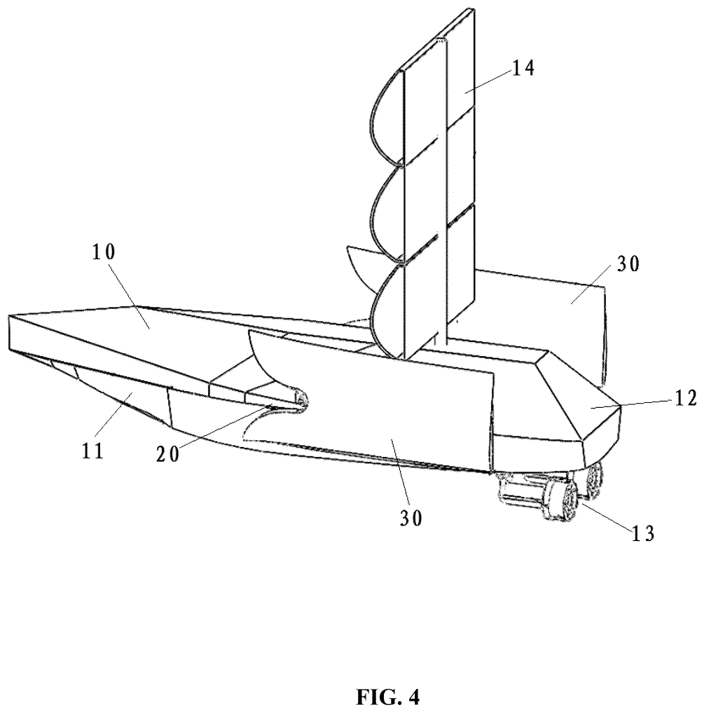

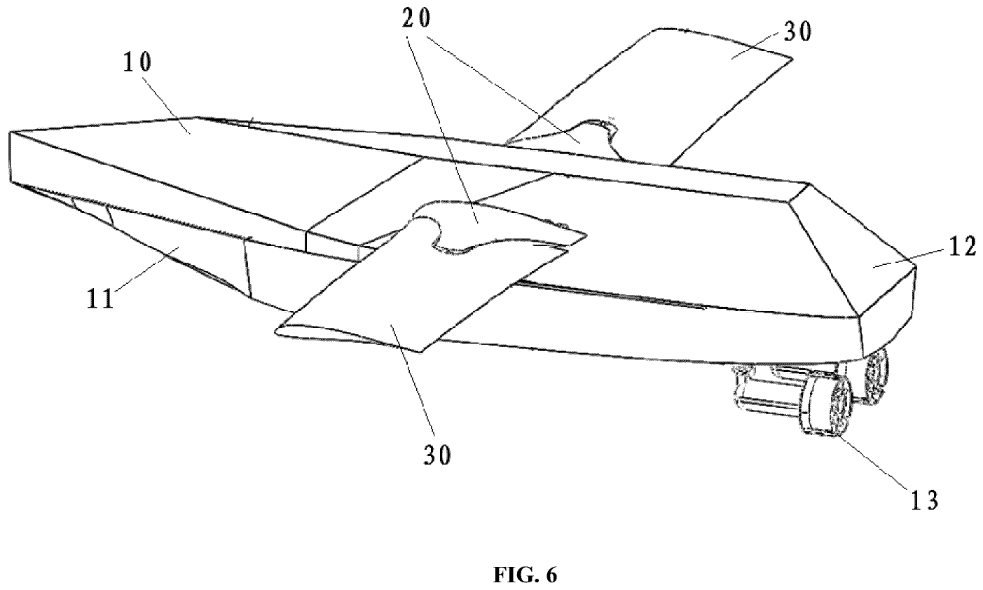

Referring to FIGS. 1-6, an embodiment of this application provides a cross-medium unmanned craft, including a main hull 10, side hulls 30 set on both sides of the main hull 10 respectively, and a propeller 13 set under or behind the main hull 10, and a rudder set at the rear of the main hull 10, preferably, the main hull 10 can have a streamlined shape (corresponding to FIG. 1-FIG. 3) and a non-streamlined shape (corresponding to FIG. 4-FIG. 6), the shape of the main hull 10 can be set according to the actual needs, which is not described in detail. The propeller 13 can be set below or on the rear side of the main hull 10. A cross profile of the side hulls 30 is an airfoil and can be flipped relative to the main hull 10. When the side hulls 30 are flipped in different attitudes, it can realize the variant of the unmanned craft, so that the unmanned craft has different shapes and structures. The rudder can rotate around the longitudinal axis of the main hull 10.

In addition, the wing root 20 is arranged on both sides of the main hull 10, one end of the wing root 20 is connected to the side of the main hull 10, and the other end is connected to the side hulls 30. One end of the wing root 20 is provided with a first driving mechanism 21, which is used to drive the wing root 20 to fold and rotate relative to the main hull 10. The other end of the wing root 20 is equipped with a second driving mechanism 31, which is used to drive the side hulls 30 to fold and rotate relative to the wing root 20. When the cross-medium unmanned craft is in a water surface navigation mode, a cross profile of the side hulls is an airfoil, and the leading edge of the airfoil is on the top and the trailing edge is on the bottom.

When the two side hulls 30 flip to both sides of the main hull 10 and form a trimaran ship configuration with the main hull 10, the cross-medium unmanned craft is in a surface navigation mode. Specifically, the side hulls 30 are folded relative to the wing root 20, and the far end of the side hulls 30 rotates backward to a suitable position and is fixed, thus forming a trimaran ship configuration in parallel with the main hull 10. Correspondingly, the propeller is in low power consumption mode, and can work together with the concealed sail 14 to promote the navigation of the unmanned boat. The main hull 10 and the side hulls 30 are connected by the wing root 20 to form a trimaran ship configuration; a cross profile of side hulls 30 is an airfoil, the leading edge of the thicker airfoil is on the top, and the trailing edge of the thinner airfoil is on the bottom, which increases the stability of the trimaran ship configuration and reduces the resistance of the water surface navigation; the rudder rotates to the upper and lower sides of the tail of the cross-medium unmanned craft, and the upper rudder is in the air, as the sail of the cross-medium unmanned craft, it provides the power for the forward and steering of the cross-medium unmanned craft; the rudder on the lower side is in the water, which acts as the stern rudder of the cross-medium unmanned craft to control the navigation.

When the two side hulls 30 are expanded relative to the main hull 10, the cross-medium unmanned craft is in a flight mode. Specifically, when the unmanned craft switches from the surface navigation mode to the flight mode, the unmanned craft changes from a trimaran ship configuration to an aircraft shape with two wings expanded, at this time, the hulls on both sides of the trimaran turn 30 outwards and morph into two wings of the unmanned craft, at this time, the two side hulls 30 constitute the wings on both sides of the main hull 1, and the wing generates lift to lift the main hull 10 until the unmanned craft leaves the water surface. Correspondingly, the propeller enters a full power mode and accelerates the navigation of the unmanned craft through high-speed water jet; when the main hull 10 leaves the water surface, the propeller 13 provides forward power for the unmanned craft through jet to achieve rapid flight in the air. When the cross-medium unmanned craft is in the flight mode and navigates on the water surface, the side hulls 30 act as a wing to generate a lifting force, so that the cross-medium unmanned craft is lifted up, reducing the draft depth of the cross-medium unmanned craft and reducing the navigation resistance, the faster the navigation speed of the cross-medium unmanned craft, the greater the lift generated by the wing, the smaller the draft depth of the cross-medium unmanned craft, and the smaller the navigation resistance; when the cross-medium unmanned craft accelerates to the wing to produce a corresponding lift, the cross-medium unmanned craft is completely separated from the water surface and is in the air flight state; when the cross-medium unmanned craft is in the flight mode, the stern rudder rotates to both sides of the main hull 10 and tilts upward to form the stern wing of the cross-medium unmanned craft.

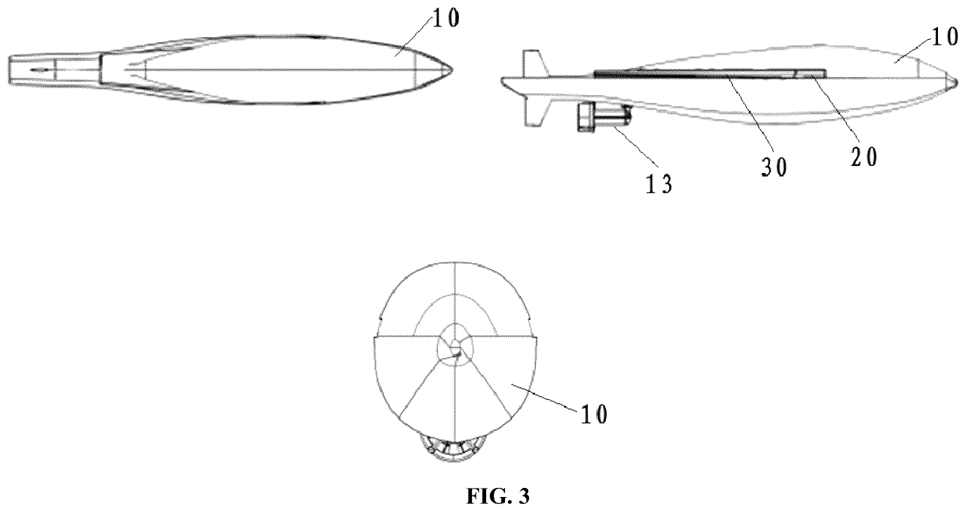

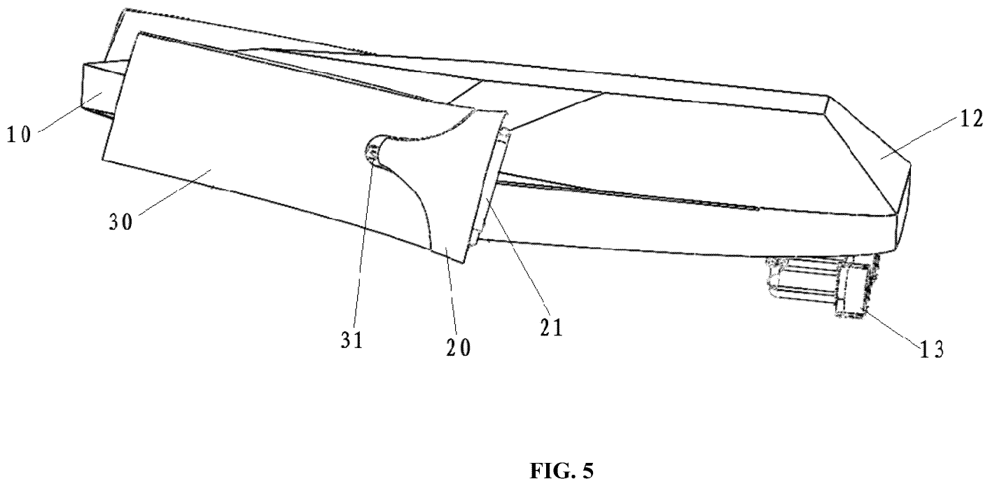

When the two side hulls 30 are turned over to the sides of the main hull 10 or stored inside the main hull 10, the cross-medium unmanned craft is in a submergence mode. Specifically, the wing root 20 and the side hulls 30 further are folded and flipped from the end to the state of being close to the main hull 10 or being stored in the main hull 10, and the rudder of the side hulls 30 are extended slightly downward and outward, acting as the stern rudder or lateral fins of the unmanned craft to control the dive attitude of the unmanned craft. Specifically, FIG. 3 corresponds to the variant form of the two side hulls 30 flipping to the two sides of the main hull 10, FIG. 5 corresponds to the variant form of two side hulls 30 flips into the main hull 10. When the side hulls 30 are flipped and stored inside the main hull 10, the leading edge of the side hulls 30 faces the inside of the main hull 10, and the trailing edge of the side hulls 30 faces the outside of the main hull 10, which constitutes the lateral fins or stern rudders of the cross-medium unmanned craft during diving; when the side hulls 30 are flipped and fit with the side of the main hull 10, the leading edge of the side hulls 30 fits the side of the main hull 10, and the trailing edge of the side hull 30 leans downward and outward, forming the lateral fins or stern rudders of the cross-medium unmanned craft during diving. When the cross-medium unmanned craft is in a submergence mode, the stern rudder rotates to the upper and lower sides of the tail of the cross-medium unmanned craft, and together with the trailing edge of the side hulls 30, which constitutes the stern rudder of the cross-medium unmanned craft.

The rudder can perform different orientation switching respectively when the cross-medium unmanned craft is in water surface navigation mode, flight mode or submergence mode.

The cross-medium unmanned craft uses the cross-media high-efficiency jet propulsion system to construct the propeller 13. The propeller 13 switches between different working modes when the unmanned craft is in surface navigation mode, flight mode or submergence mode. Specifically, when the cross-medium unmanned craft is in the flight mode, the propeller 13 is in a jet propulsion mode; when the cross-medium unmanned craft is in the surface navigation mode or the submergence mode, the propeller 13 is in a sprinkling propulsion mode.

The head and tail of the main hull 10 are also equipped with a front cabin 11 and a rear cabin 12, respectively, the limited connectivity between the front cabin 11 and the rear cabin 12 enables the transfer of water or air from the front cabin 11 to the rear cabin 12, or from the rear cabin 12 to the front cabin 11. For example, when the propeller 13 is in the jet propulsion mode, the propeller modulates the air transmission of the front cabin 11 and the rear cabin 12, when the propeller 13 is in the sprinkling propulsion mode, the propeller modulates the water transport in the front cabin 11 and the rear cabin 12.

Specifically, when the unmanned craft needs to dive smoothly and slowly to the water, the unmanned craft is adjusted to the level, the front cabin 11 and the rear cabin 12 are injected with water at the same time, and the unmanned craft is kept at the level during the diving; when the unmanned craft needs to dive quickly, by adjusting the amount of water in the front cabin 11 and the rear cabin 12, the amount of water in the front cabin 11 is more than that in the rear cabin 12, so that the unmanned craft keeps its head down. When the unmanned craft needs to float steadily and slowly, the unmanned craft is adjusted to the horizontal level, the front cabin 11 and the rear cabin 12 are drained at the same time, and the unmanned craft is kept at the horizontal level during the floating process; when the unmanned craft needs to dive quickly, by adjusting the water volume of the front cabin 11 and the rear cabin 12, the water volume of the rear cabin 12 is more than that of the front cabin 11, so that the unmanned craft can keep its head up. Meanwhile, the power of the unmanned craft is provided by the propeller 13, which is used to push the unmanned craft to dive or float forward quickly.

The cross-medium unmanned craft also includes a concealed sail 14, a solar photovoltaic membrane and wave energy converters, through photovoltaic power generation, wind and wave power generation provide power for the movement of unmanned craft, achieving low power consumption forward and extending the endurance time. In addition, the main hull 10 can also be equipped with a fuel generator for power generation. Wherein, the concealed sail 14 is set on the rear side of the main hull 10, which can be folded relative to the main hull 10; the concealed sail 14 can use wind to promote the movement of cross-medium unmanned craft, the solar photovoltaic membrane can be set on the surface of the main hull 10 and the surface of the concealed sail; the wave energy converters are set at the connection between the side hulls 30 and the main hull 10. In addition, the cross-medium unmanned craft also includes an energy storage equipment. Wherein, the energy storage devices can be, but are not limited to, large-capacity batteries; the energy storage device is connected to a concealed sail 14, a solar photovoltaic membrane, wave energy converters, and a fuel generator for storing electrical energy and providing electrical energy to thruster 13 or other devices.

As the control center of the whole unmanned craft, the main hull 10 coordinates the operation of each part, mainly for information reconnaissance, communication, data acquisition and target locking. The main hull 10 can also store fuel, batteries and detection devices. When performing tasks such as daily patrols, the propeller 13 selects low-power propulsion; when performing a burst mission, the propeller 13 selects full power propulsion.

The cross-medium unmanned craft applied in this application has the ability of long-term ocean-going duty and high-speed flight in the air, energy-saving navigation on the water surface, and underwater concealed diving. By designing the drag reduction configuration and variant scheme of the trimaran ship, the cross-medium unmanned craft has a development of cross-medium high-efficiency jet propeller, the integrated ocean-going variant cross-medium unmanned craft is used to perform far sea missions, and can also be used in civil and military fields such as ocean patrol, personnel search and rescue, and fish tracking.

The application of the cross-medium unmanned craft is usually set in the fixed sea low speed cruise, patrol in a specific area, rely on new energy such as solar energy, wave energy, wind energy and other energy self-sufficiency. When the emergency task command is received, the full speed is advanced, and the new energy equipment such as sails is recovered, when the ship speed reaches a set value, the side hulls 30 gradually can be flipped to form a wing with the main hull 10, the power of the propeller power is turned to the maximum and converted into jet propulsion until the main hull 10 is completely lifted off the water surface and flies at full speed. When it is close to the target location, it gradually slides down the water surface to restore the trimaran ship configuration but does not expand the sail, and sails to the target at a high speed. In the event of an accident, the first time response enters the air rapid navigation state, arrives at the maximum speed and converts to the water surface energy-saving state, and uses underwater detection and other related technologies for rescue. The military side is used for daily patrols in the territorial waters. In case of emergency, the high-speed response of the working condition conversion arrives at the scene and performs the task.

After receiving the command of the control center, the cross-medium unmanned craft applied for this application will fold the concealed sail 14 and retract it, expand the wing, and operate the jet propulsion system. The unmanned craft is changed from sail wind propulsion to water jet propulsion in the state of energy-saving navigation on the water surface, the lift generated by the wing is used to lift the main hull 10, at this time, the speed of the unmanned craft is controlled, so that the main hull 10 has as little drainage as possible but does not leave the water surface. On the one hand, the ultimate drag reduction can be achieved, on the other hand, since the main hull 10 is not separated from the water surface, the propeller 13 has been in the water jet propulsion mode, which is more efficient and energy-saving than the jet propulsion after being separated from the water surface. When the unmanned craft is close to the target, the propeller 13 runs at full speed, and the unmanned craft accelerates further, at this time, the lift generated by the wing causes the unmanned craft to leave the water surface, and the unmanned craft flies at high speed to reach the task site at the fastest speed.

For some special cases, high concealment is required to approach the target and perform subsequent tasks. In response to this situation, after receiving the command of the control center, the unmanned surface vehicle will fold the concealed sail 14 and retract it, and expand the wing, then the propeller 13 runs. The unmanned craft is transformed from sail wind propulsion to water jet propulsion in the energy-saving navigation state of the water surface, the lift generated by the wing is used to lift the main hull 10, control the speed of the unmanned surface vehicle, and make the main hull 10 drain as little as possible but not out of the water surface. Before approaching the target detection range, the unmanned craft decelerates, folds and retracts the side hull 30 to the main hull 10, the unmanned craft changes into a submerged form, adjusts the attitude of the unmanned craft and submerges, then the propeller 13 promotes the unmanned craft to submerge underwater to the target.

In addition, multiple cross-medium unmanned crafts can be arranged near accident-prone sea areas, in daily situations, the unmanned crafts can use renewable energy to promote the slow navigation of unmanned boats to patrol in the area. When a crash occurs, the unmanned crafts quickly gathers according to the location of the accident report, and quickly reaches the crash location with high power and high speed to carry out search and rescue operations. Meanwhile, the hull is equipped with a series of detection devices to detect personnel, and the communication system is carried out to transmit the crash situation in real time.

In addition, the cross-medium unmanned craft can be set up in the fishing area, low-power operation combined with new energy self-generating equipment can achieve long-term monitoring of fish conditions, the bottom of the ship is equipped with acoustic sensors, the bow has an optical system and a camera, after receiving the instructions, it can dive into deep water to explore the number and species of fish and transmit the data back to the ground to realize the detection of underwater fish conditions and marine environment.

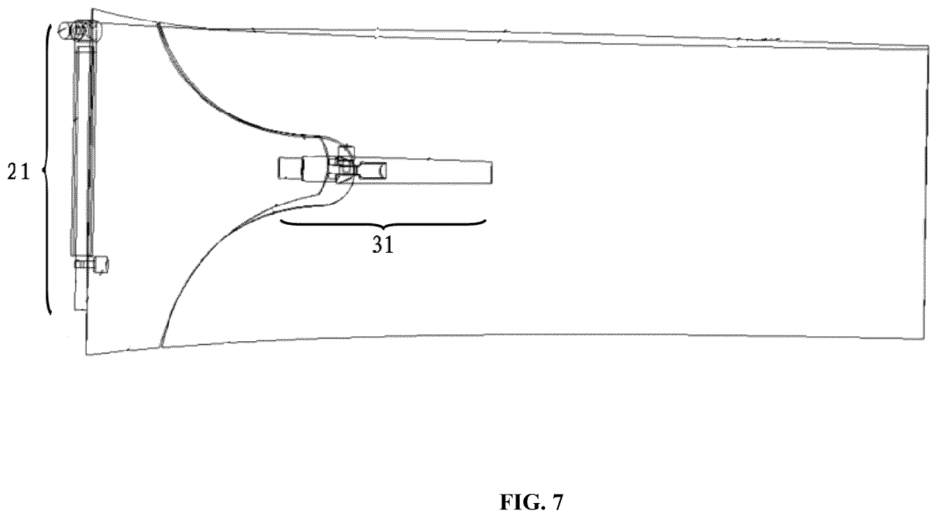

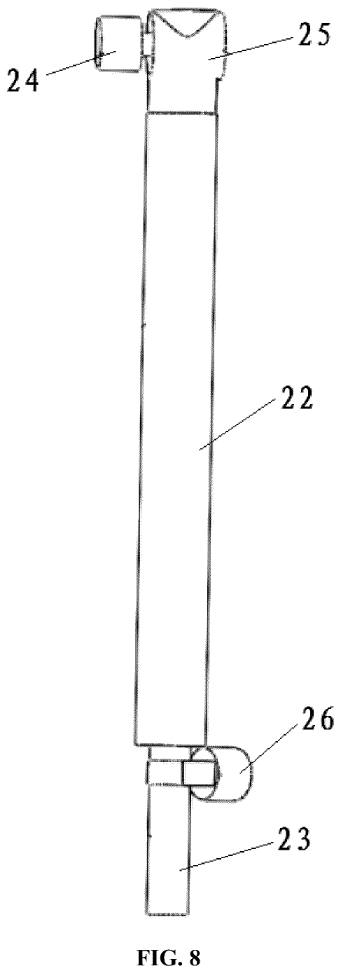

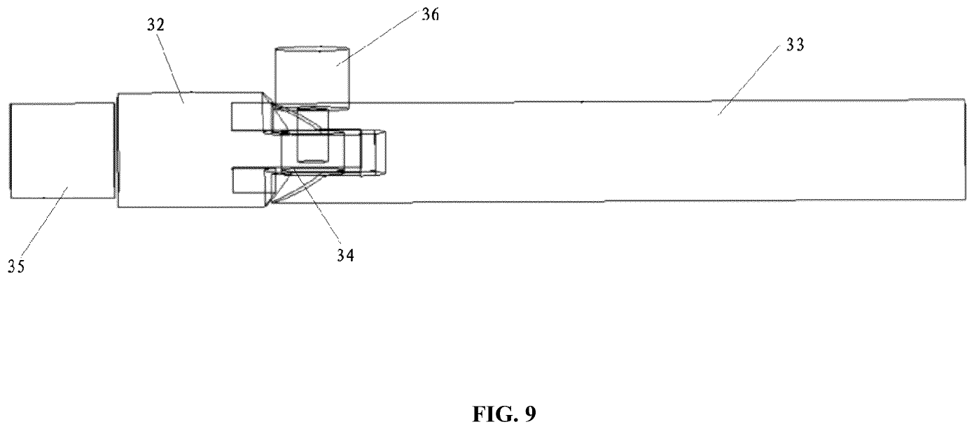

Referring to FIGS. 7-9, in order to ensure that the wing root 20 and the side hulls 30 can flip and fold freely, a first driving mechanism 21 is set at one end of the wing root 20 to drive the wing root 20 to fold and rotate relative to the main hull 10, and a second driving mechanism 31 is set at the other end of the wing root 20 to drive the side hull 30 to fold and rotate relative to the wing root 20.

The first drive mechanism 21 may include a hinge sleeve 22, a hinge shaft 23, a first motor 24, a shaft of side rotation 25 and a second motor 26. Wherein, the first motor 24 and the second motor 26 can but are not limited to torque motors, the hinge sleeve 22 is set at the position where the side of the main hull 10 is connected to the wing root 20, the shaft of side rotation 25 is placed on the side of the main hull 10, and the hinge shaft 23 is set on the side where the wing root 20 is connected to the side of the main hull 10. The first motor 24 is connected with the shaft of side rotation 25 to drive the shaft of side rotation 25 to rotate, the second motor 26 is connected with the hinge shaft 23 to drive the hinge shaft 23 to rotate. The shaft of side rotation 25 and the hinge rotation axis 23 respectively realizes the flip folding of the wing root 20 relative to the main hull 10. For example, when the wing rotates and fits, the side hulls 30 and the main hull 10 are in the wing expansion state first, the hinge sleeve 22 and the hinge shaft 23 cooperate to drive the overall wing to rotate in the water surface direction, it is connected to the shaft of side rotation 25 to drive the wing to rotate to the side direction of the main hull 10 until it is attached to the surface of the main hull 10.

The second drive mechanism 31 may include a front section shaft 32, a rear section shaft 33, a mortise-tenon joint 34, a gear group, a third motor 35 and a fourth motor 36. Wherein, the third motor 35 and the fourth motor 36 can but are not limited to torque motors, the gear group (not shown in the figure) and the front section shaft 32 are set in the wing root 20, and the rear section shaft 33 is set in the side hulls 30, and the front section shaft 32 and the rear section shaft 33 are connected by the mortise-tenon joint 34. The third motor 35 is driven by the gear group and the front section shaft 32, and the fourth motor 36 is driven by the rear section shaft 33, when the wing is folded, the gear group drives the front section shaft 32 to rotate as a whole, and the rear section shaft 33 drives the side hulls 30 to rotate in the stern direction to realize the folding step of the wing.

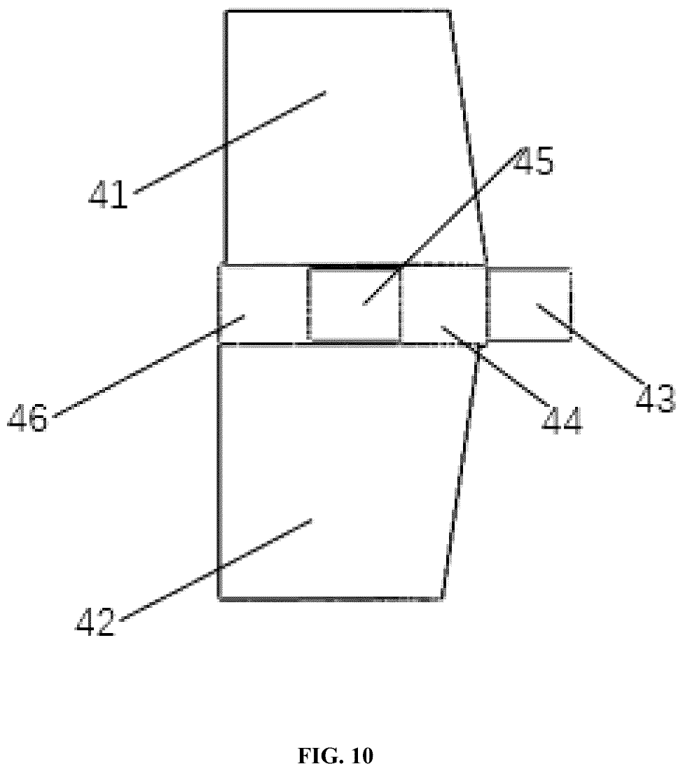

Referring to FIG. 10, in order to ensure that the rudder can be deformed accordingly when the cross-medium unmanned craft is in the surface navigation mode, flight mode or diving mode, so as to improve the motion efficiency of the cross-medium unmanned craft. Specifically, the stern part of main hull 10 is provided with stern rudder 41 and stern rudder 42 respectively; wherein, the stern rudder 41 is connected with the shaft 44, and the stern rudder 42 is connected with the shaft 46; torque motors are set in the shaft 43 and the shaft 45 respectively, the shaft 43 and the shaft 44 are connected by torque motor, the shaft 45 and the shaft 44 are directly connected, the shaft 45 and the shaft 46 are connected by torque motor. When the stern rudder needs to be deformed accordingly, the rotation of the shaft 43 drives the stern rudder 41 to rotate to the appropriate position, and the rotation of the shaft 45 drives the stern rudder 42 to rotate to the appropriate position.

The rudder of the cross-medium unmanned craft can rotate around the longitudinal axis of the hull, when the cross-medium unmanned craft is in the flight mode, the stern rudder 41 and the stern rudder 42 rotate to the two sides of the main hull 10 obliquely, forming the rudder of the cross-medium unmanned craft; when the cross-medium unmanned craft is in the surface navigation mode, the stern rudder 41 and the stern rudder 42 rotate to the upper and lower sides respectively, the downward side is used as the stern rudder of the cross-medium unmanned craft, and the upward side is used as the sail of the cross-medium unmanned craft; When the unmanned craft is in the submarine mode, the stern rudder 41 and the stern rudder 42 are on the upper and lower sides respectively, which together with the side hulls 30 constitute the submarine tail rudder.

In general, the cross-medium unmanned craft applied in this application can realize cross-medium and multi-environment work, adapt to complex environment, have sufficient energy supply and can sail for a long time, and expand the mission scope of unmanned craft. The unmanned craft can also realize underwater diving, improve the concealment and the accuracy of underwater exploration, and can also realize water flight, improve the rapidity of command response and the efficiency of reaching the execution site. The cross-medium unmanned craft applied in this application has the characteristics of long endurance, variability and fast response, it can realize long endurance patrol, large-scale multi-dimensional exploration, monitoring, fast response, low resistance and fast navigation in the open sea area to the greatest extent. It has the ability of long endurance, concealment and rapidity, and realizes the functions of water surface, air and underwater.

The above is only a specific implementation method of the invention, and any other improvements based on the premise of the invention are regarded as the scope of protection of the present invention.

What is claimed is:

1. A morphing cross-medium unmanned craft, comprising a main hull, side hulls set on both sides of the main hull respectively, a rudder set at the rear of the main hull and a propeller set under or behind the main hull, a cross profile of the side hulls is an airfoil and the side hulls can be flipped relative to the main hull, and the rudder can rotate around the longitudinal axis of the main hull;
when the two side hulls are flipped to both sides of the main hull and form a trimaran ship configuration with the main hull, the cross-medium unmanned craft is in a surface navigation mode;
when the two side hulls are expanded relative to the main hull, the cross-medium unmanned craft is in a flight mode, and the two side hulls form the wings on both sides of the main hull; when the two side hulls are flipped to fit with the two sides of the main hull or are stored inside the main hull, the cross-medium unmanned craft is in the submergence mode, and the two side hulls form the outward rudder or lateral fins on both sides of the main hull;
the propeller can perform different working mode switching respectively when the cross-medium unmanned craft is in water surface navigation mode, flight mode or submergence mode;
the rudder can perform different orientation switching respectively when the cross-medium unmanned craft is in water surface navigation mode, flight mode or submergence mode.

2. The morphing cross-medium unmanned craft according to claim 1, wherein it also includes a wing root set on both sides of the main hull; one end of the wing root is connected with the side of the main hull, the other end is connected with the side hulls; the wing root can fold and rotate relative to the main hull, and the side hulls can fold and rotate relative to the wing root.

3. The morphing cross-medium unmanned craft according to claim 1, wherein when cross-medium unmanned craft is in a water surface navigation mode, the wing root and the side hulls perform actions separately, so that the wing root is horizontally expanded and the side hulls are vertically oriented and parallel to the length direction of the main hull;
the main hull and the side hulls are connected by the wing root to form a trimaran ship configuration;
a cross profile of the side hulls is an airfoil, the leading edge of the thicker airfoil is on the top, and the trailing edge of the thinner airfoil is on the bottom;
the rudder rotates to the upper and lower sides of the tail of the cross-medium unmanned craft, the rudder on the upper side is in the air, as the sail of the cross-medium unmanned craft, it provides forward and steering power for the surface navigation of the cross-medium unmanned craft; the rudder on the lower side is in the water, and acts as the rudder of the cross-medium unmanned craft to control the navigation.

4. The morphing cross-medium unmanned craft according to claim 1, wherein when the cross-medium unmanned craft is in a flight mode, the wing root and the side hulls perform actions separately, so that the wing root and the side hulls are both in horizontal expansion state, forming the wings on both sides of the main hull;
when the cross-medium unmanned craft is in a flight mode and navigates on the water surface, the side hulls act as a wing to generate a lifting force, so that the cross-medium unmanned craft can be lifted up; when the cross-medium unmanned craft surface accelerates to the wing to generate a corresponding lift, the cross-medium unmanned craft is completely separated from the water surface and is in the air flight state;
when the cross-medium unmanned craft is in the flight mode, the rudder rotates to both sides of the main hull and tilts upward to form the rubber of the cross-medium unmanned craft.

5. The morphing cross-medium unmanned craft according to claim 1, wherein when the the cross-medium unmanned craft is in a submergence mode, the wing root and the side hulls perform actions separately, so that the wing root and the side hulls are turned to fit with the two sides of the main hull or to be stored inside the main hull;
when the side hulls are flipped and stored inside the main hull, the leading edge of the side hull faces to the inside of the main hull, and the trailing edge of the side hull faces to the outside of the main hull, which constitutes the lateral fins or stern rudder of the cross-medium unmanned craft during diving; when the side hull flips and fits with the side of the main hull, the leading edge of the side hulls fits the side of the main hull, the trailing edge of the side hull is inclined downward and outward, which constitutes the lateral fins or stern rudder of the cross-medium unmanned craft during diving;
when the cross-medium unmanned craft is in a submergence mode, the stern rudder rotates to the upper and lower sides of the tail of the cross-medium unmanned craft, and together with the trailing edge of the side hulls constitutes the stern rudder of the cross-medium unmanned craft.

6. The morphing cross-medium unmanned craft according to claim 1, wherein when the cross-medium unmanned craft is in a flight mode, the propeller is in a jet propulsion mode; when the cross-medium unmanned craft is in surface navigation mode or submerged mode, the propeller is in a sprinkling propulsion mode.

7. The morphing cross-medium unmanned craft according to claim 6, wherein it also includes a front cabin and a rear cabin located at the head and tail of the main hull respectively; the front cabin is interconnected with the rear cabin; when the propeller is in a jet propulsion mode, the air transmission modulation is performed on the front cabin and the rear cabin; when the propeller is in a sprinkling propulsion mode, the water transmission modulation is performed on the front cabin and the rear cabin.

8. The morphing cross-medium unmanned craft according to claim 1, wherein it also includes a concealed sail which is arranged on the rear side of the main hull and can be folded relative to the main hull; the concealed sail can use the wind to drive the cross-medium unmanned craft to move or generate electricity;
or, a fuel generator is arranged inside the main hull for power generation.

9. The morphing cross-medium unmanned craft according to claim 8, wherein it also includes a solar photovoltaic membrane and wave energy converters; the solar photovoltaic membrane is arranged on the surface of the main hull and the surface of the concealed sail; the wave energy converters are arranged at the connection between the side hulls and the main hull.

10. The morphing cross-medium unmanned craft according to claim 9, wherein it also includes an energy storage device; the energy storage device is connected to the concealed sail, the solar photovoltaic membrane, the wave energy converters and the fuel generator for storing electric energy.
